(19) United States
(12) Patent Application Publication
(10) Pub. No.: US 2006/0143038 A1
(43) Pub. Date: Jun. 29, 2006

(54) Method of and system for distributing secure items

(76) Inventor: Colleen Anne Sainsbury, Florida (ZA)

Correspondence Address: FROMMER LAWRENCE & HAUG, 745 FIFTH AVENUE- 10TH FL., NEW YORK, NY, 10151, US

(21) Appl. No.: 11/315,460

(22) Filed: Dec. 22, 2005

(30) Foreign Application Priority Data
Dec. 23, 2004 (ZA) 2004/10383

(51) Int. Cl. G06Q 99/00

(52) U.S. Cl. 705/1

(57) ABSTRACT

A method of and system for distributing secure items, monitoring the distribution process and producing alarms in the event of errors are disclosed. The method comprises the steps of receiving pre-delivery data at a distribution server, the data detailing a plurality of secure items which will be received at a distribution centre, receiving a plurality of secure items at the distribution centre and capturing data identifying the received plurality of secure items, comparing the data identifying the received plurality of secure items with the received pre-delivery data, and producing an alarm if any secure items was received which should not have been receiv0ed or if any secure item was not received which should have been received.

This application claims priority benefits from South African Patent Application No. 2004/10383 filed Dec. 23, 2004.

### BACKGROUND OF THE INVENTION

THIS invention relates to a method of and system for distributing secure items including monitoring the distribution process and producing alarms in the event of errors.

The prototype of the present invention was particularly developed for the delivery of credit cards from a financial institution to its clients, but it will be appreciated that the present invention could equally be used for other kinds of financial instruments or any other valuable article/secure item.

In any event, there are a large number of credit cards which need to be delivered to customers of financial institutions on a daily basis. Because of the inherent risks of the credit card falling into the wrong hands and being used for fraudulent purchases, the credit cards need to be securely delivered to the correct person. Furthermore, if a card goes missing it is imperative that the missing card is identified as soon as possible to prevent fraudulent purchases using the card.

Thus, a secure or automated sorting and delivery system and process is required which produces alarms in the event of errors to bring missing cards to the attention of a system manager.

The present invention seeks to address this.

### SUMMARY OF THE INVENTION

According to a first aspect of the invention there is provided a method of distributing secure items, monitoring the distribution process and producing alarms in the event of errors, the method comprising the steps of:
receiving pre-delivery data at a distribution server, the data detailing a plurality of secure items which will be received at a distribution centre;
receiving a plurality of secure items at the distribution centre and capturing data identifying the received plurality of secure items;
comparing the data identifying the received plurality of secure items with the received pre-delivery data; and
producing an alarm if any secure items was received which should not have been received or if any secure item was not received which should have been received.

Conveniently, the method further includes the step of determining whether each received secure item is ready for delivery to a customer.

If the received secure item is ready for delivery, the method further includes the steps of:
compiling delivery data detailing the secure item to be delivered;
preparing the secure item to be delivered and capturing data detailing the prepared secure item to be delivered;
comparing the delivery data with the data captured from the prepared secure item to be delivered; and
producing an alarm if any secure item was prepared for delivery which should not have been or if any secure item was not prepared for delivery which should have been.

Preferably, the method further includes the steps of:
compiling data detailing whether the prepared secure item was successfully delivered or whether it was returned to the distribution centre;
comparing the compiled data with the delivery data; and
producing an alarm if the secure item was neither delivered nor returned.

If, however, the received secure item is not ready for delivery, the method further includes the step of scanning the secure item into a vault.

Typically, the method further includes the steps of:
receiving retrieval order data for a secure item;
scanning the ordered secure item out of the vault;
preparing the ordered secure item to be delivered and capturing data detailing the ordered secure item to be delivered;
comparing the retrieval order data with the data captured from the prepared ordered secure item to be delivered; and
producing an alarm if any secure item was prepared for delivery which should not have been or if any secure item was not prepared for delivery which should have been.

Conveniently, the method further includes the steps of:
monitoring the duration that a secure item is stored in the vault; and
when the duration of the secure item in the vault exceeds a predetermined amount, the method further includes the steps of:
   compiling destruction data detailing the secure item to be destroyed;
   preparing the secure item to be destroyed and capturing data detailing the secure item to be destroyed;
   comparing the destruction data with the data captured from the prepared secure item to be destroyed; and
   producing an alarm if any secure item was prepared for destruction which should not have been or if any secure item was not prepared for destruction which should have been.

Preferably, the method further includes the steps of:
compiling pre-delivery data at the distribution server, the data detailing a plurality of secure items which are to be delivered to a remote distribution centre; and
sending the pre-delivery data to the remote distribution centre.

Conveniently, the method further includes the steps of:
preparing the plurality of secure items to be delivered to the remote distribution centre and capturing data detailing the plurality of secure items to be delivered;
comparing the pre-delivery data with the data captured from the prepared plurality of secure items to be delivered to the remote distribution centre; and
producing an alarm if any secure item was prepared for delivery to the remote distribution centre which should not have been or if any secure item was not prepared for delivery to the remote distribution centre which should have been.

According to a second aspect of the invention there is provided a system for distributing secure items, monitoring the distribution process and producing alarms in the event of errors, the system comprising a processor that can:
receive pre-delivery data, the data detailing a plurality of secure items which will be received at a distribution centre;
capture data identifying a plurality of secure items received at the distribution centre;
compare the data identifying the received plurality of secure items with the pre-delivery data; and
produce an alarm if any secure item was received which should not have been received or if any secure item was not received which should have been received.

Conveniently, the processor can further execute the additional steps defined above.

### BRIEF DESCRIPTION OF THE DRAWINGS

FIG. 1 is a flow chart illustrating the receiving and sorting of secure items at a distribution centre;

FIGS. 2, 3 and 4 illustrate the preparation for delivery of the secure items;

FIG. 5 illustrates the delivery process;

FIG. 6 illustrates a secure item recall process;

FIG. 7 illustrates an emergency delivery process;

FIG. 8 shows an animated version of the flow chart shown in FIG. 1;

FIG. 9 shows a detailed animated flow chart of a stock holding specialization feature of the flow chart shown in FIG. 8;

FIG. 10 shows a detailed animated flow chart of a linked items specialization feature of the flow chart shown in FIG. 8;

FIG. 11 shows a detailed animated flow chart of various functions performed by a call centre used in the flow chart shown in FIG. 8;

FIG. 12 shows a detailed animated flow chart of various functions performed by a storage vault shown in FIG. 8;

FIG. 13 shows an animated version of the flow charts shown in FIGS. 2 and 3;

FIG. 14 shows an animated version of the flow chart shown in FIG. 4;

FIG. 15 shows an animated version of a first delivery type shown in FIG. 5;

FIG. 16 shows an animated version of a second delivery type shown in FIG. 5;

FIGS. 17 and 18 show an animated version of a return process;

FIGS. 19 and 20 show an animated version of the secure item recall process shown in FIG. 6; and

FIG. 21 shows an animated version of the emergency delivery process shown in FIG. 7.

### DESCRIPTION OF PREFERRED EMBODIMENTS

The present invention finds particular application in the delivery of credit cards issued by a financial institution/bank to its customers. However, it will be appreciated that the present invention could find application in the delivery of other kinds of secure items including other kinds of financial instruments such as debit cards, cheque books, share certificates, or even mobile banking cards, to name just a few examples.

In addition, the present invention will be described below with reference to “Mounties” being a third party delivery organisation. However, it will be appreciated that the present invention could find equal application by the financial institution itself.

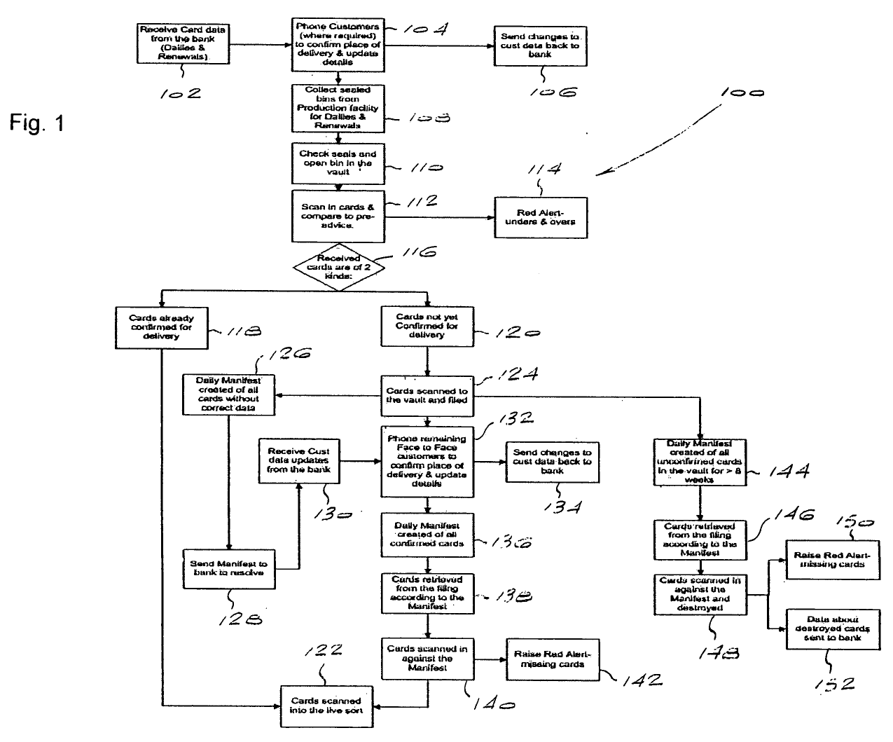

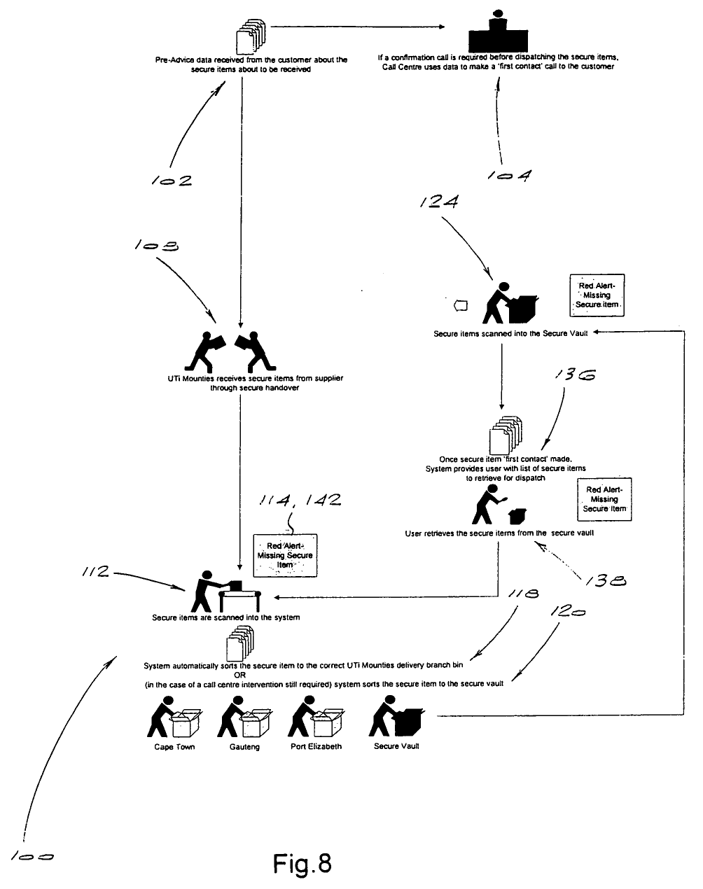

Referring to the accompanying FIGS. 1 and 8, the process begins by receiving pre-delivery card data at a distribution server (block/arrow 102). The data will typically detail the plurality of cards to be received at a distribution centre, and will typically come from a customer bank.

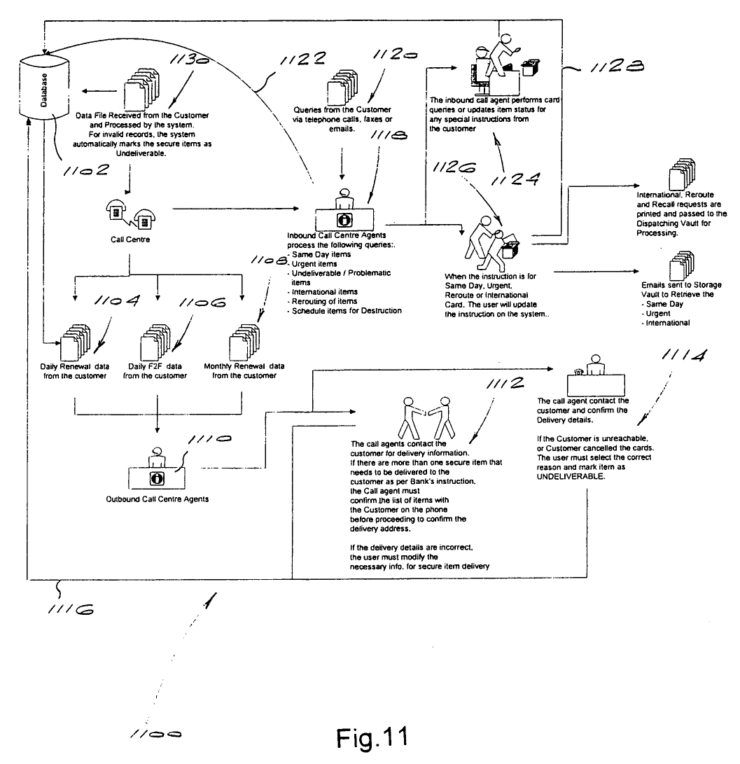

Customers are called where required (block/arrow 104) to confirm the place of delivery and if necessary to update the details received from the Bank. Any necessary changes are sent back to the bank (block 106). The Call Centre functionality will be described in more detail below with reference to FIG. 11.

A plurality of cards are received at a distribution centre which have typically been collected from a production facility (block/arrow 108). It will be appreciated that the cards will be packed in sealed containers. On arrival, the seals are checked and the containers are opened, typically in a vault (block 110).

Data identifying the credit cards is captured typically by scanning in a bar code associated with the card and this captured data is compared with the pre-delivery data identifying the plurality of cards which are to be received (block/arrow 112).

An alarm is produced if any of the cards which have been received should not have been received or if any of the cards were not received which should have been received (block/arrow 114). This is the first alert in the process to bring an error to the attention of a process manager.

Cards are received at the distribution centre (block 116). The cards will either be confirmed for delivery (block/arrow 118) or not (block/arrow 120). If the card is ready for delivery (block/arrow 118) it is scanned into a live sort (block 122) to begin the delivery process which will be described in more detail below.

If the card is not yet confirmed for delivery (block/arrow 118), it is scanned to the vault (block/arrow 124) and filed away. Cards may not be ready for delivery due to the fact that they have incorrect data or that the customers have not yet been contacted to confirm a place and time of delivery.

If the cards have incorrect data, a manifest is created (block 126) and sent to the bank (block 128). The bank needs to resolve the incorrect data, and once correct data is received back from the bank (block 130), the customer will be contacted to confirm a place of delivery (block 132). Any changes to the customer data will at this point be sent back to the bank (block 134).

Once confirmation of delivery with the customer has been confirmed, a daily manifest is created of all cards which need to be withdrawn from the vaults and inserted into the delivery process. In this regard, retrieval data is compiled in the form of a manifest of all cards to be retrieved and transferred to the delivery process (block/arrow 136).

The cards are then actually retrieved from the vault (block/arrow 138), and data is captured of each retrieved card by scanning the card. This data is then compared with the retrieval data (block 140). Again, an alarm is produced (block 142) if any of the cards which should have been retrieved were not retrieved or if any of the cards which should not have been retrieved have been retrieved.

In addition to the above, a daily and stock take of the unconfirmed cards which remain in the vaults are taken and any card which has remained in the vault for greater than a predetermined period of time, for example eight weeks, are highlighted. Data is compiled detailing these exceeded time cards and another manifest is created for these cards to be retrieved from the vault (block 144). The cards are then retrieved (block 146), and data identifying the retrieved cards are again captured and compared to the exceeded time data (block 148). Again, a red alert is produced if any card is retrieved which should not have been retrieved, or if any card is not retrieved which should have been retrieved (block 150). These exceeded time cards are then destroyed and data identifying the destroyed cards is sent to the bank (block 152).

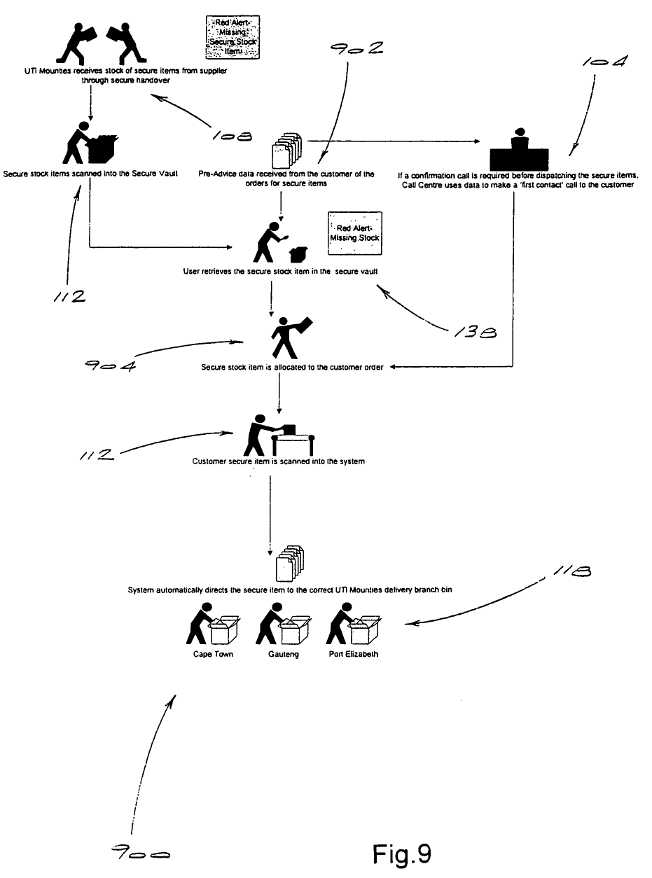

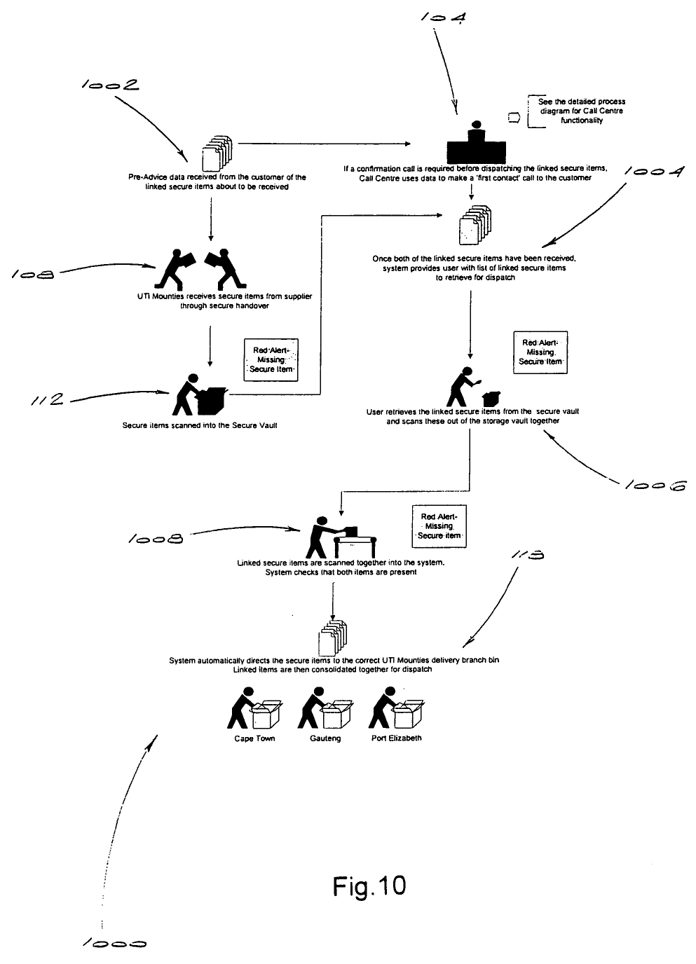

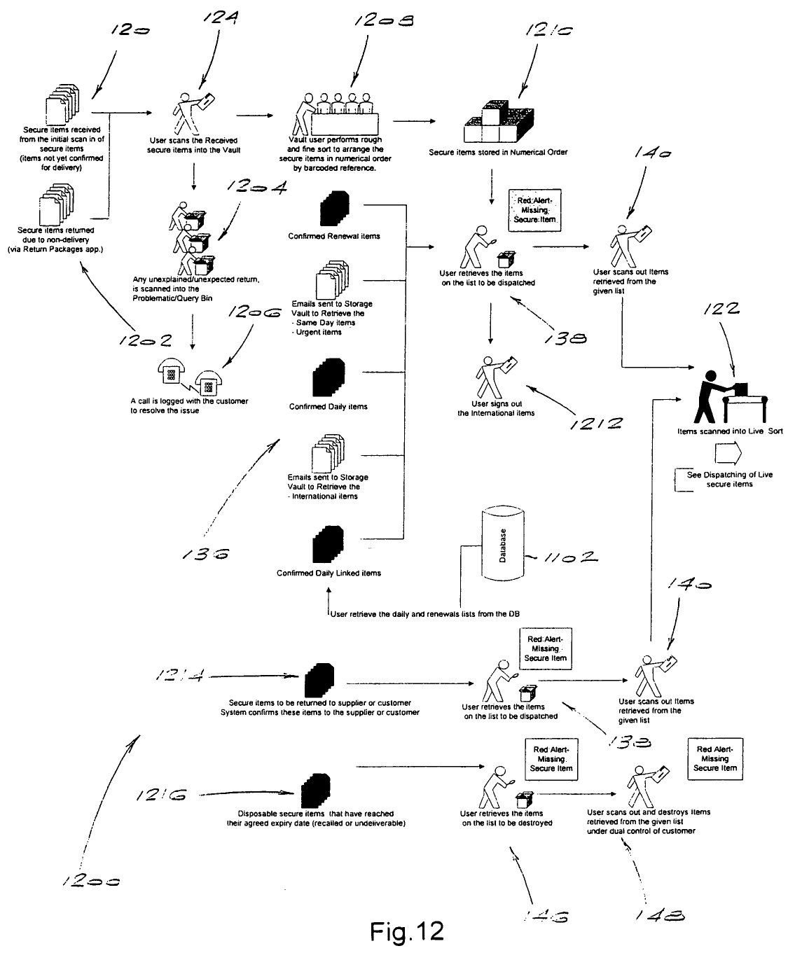

Additional functionalities/features that are part of the process 100 described above will be described with reference to FIGS. 9 to 12, these include a Stock holding specialization (FIG. 9), a Linked items specialization (FIG. 10), a Call Centre functionality (FIG. 11) and a Storage Vault functionality (FIG. 12).

Referring first to FIG. 9, a stock holding specialisation process 900 is shown in which a customer bank can order secure items stored in the secure vault. Thus, after the receipt of secure items from a supplier (arrow 108, corresponding to arrow 108 in FIG. 8), and after the secure items have been scanned into the secure vault (arrow 112, corresponding to arrow 112 in FIG. 8), the distribution server may receive pre-advice order data from a customer bank for particular secure items stored in the secure vault (arrow 902). Thereafter, the requested secure items are retrieved from the secure vault (arrow 138, corresponding to arrow 138 in FIG. 8).

If need be, the call centre may contact the customer bank prior to dispatching the ordered secure items (arrow 104, corresponding to arrow 104 in FIG. 8). The retrieved secure item is then allocated to the customer order (arrow 904), scanned into the system (arrow 112, corresponding to arrow 112 in FIG. 8), and then directed into the correct delivery branch bin (arrow 118, corresponding to arrow 118 in FIG. 8).

Turning now to FIG. 10, in some cases two or more items are linked together so that both need to be delivered to a customer, although the two or more items will not necessarily be received together at the distribution centre. In this case, a linked items specialisation functionality process 1000 will be utilized. Thus, the pre-delivery data received by the distribution server from the customer bank (arrow 1002) will include information regarding the linked secure items to be received. The usual steps of receiving the secure items from a supplier (arrow 108, corresponding to arrow 108 in FIG. 8), and scanning the secure items into the secure vault (arrow 112, corresponding to arrow 112 in FIG. 8) are then followed. Once the system detects that both of the linked items have been received, the system will generate a list of secure items to be retrieved for dispatch (arrow 1004). Again, if need be, the call centre may contact the customer bank prior to dispatching the ordered secure items (arrow 104, corresponding to arrow 104 in FIG. 8). The linked secure items are then retrieved from the secure vault (arrow 1006), scanned together into the system (arrow 1008), and then consolidated and directed into the correct delivery branch bin (arrow 118, corresponding to arrow 118 in FIG. 8).

It will be appreciated that the call centre plays an important role in the processes described above, and the call centre will now be described in more detail with reference to FIG. 11. Central to the call centre 1100 is a database 1102 that is used to produce daily renewal data from the customer (arrow 1104), daily face to face (F2F) data from the customer (arrow 1106) and monthly renewal data from the customer (arrow 1108). Outbound call centre agents 1110 use this information to contact customers for delivery information (arrow 1112) and to confirm delivery details (arrow 1114), with any relevant information arising from this interaction being updated onto the database 1102, as indicated by arrow 1116. The call centre 1100 also includes inbound call centre agents 1118 that receive queries from customers (arrow 1120). Again, any relevant information arising from this interaction is updated onto the database 1102, as indicated by arrow 1122. The inbound call centre agents 1118 also perform card queries and update item statuses (arrow 1124), and delegate tasks to other personnel (arrow 1126). Again, any relevant information arising from this interaction is updated onto the database 1102, as indicated by arrow 1128. The database 1102 also stores the various data files described above (arrows 102, 902 and 1002), as indicated by arrow 1130.

Another important component in the general process 100 described above with reference to FIGS. 1 and 8, is the secure vault, with its various associated processes 1200 now being described in more detail with reference to FIG. 12. As described above, if the card is not yet confirmed for delivery (block/arrow 120), it is scanned to the vault (arrow 124, corresponding to block 124 in FIG. 1) and filed away. Another way for a secure item to enter the secure vault is due to secure items being returned due to non-delivery (arrow 1202). The received secure items are then scanned into the vault (arrow 124), with any unexplained returns being scanned into a query bin (arrow 1204) with a call then being logged with the customer to address the query (arrow 1206). Vault personnel then sort the secure items in numerical order (arrow 1208), with the items then being stored in numerical order (arrow 1210). A request for the retrieval of a secure item can come in from any one of a number of sources, with these sources being indicated generally by arrow 136, which corresponds to arrow 136 in FIGS. 1 and 8. The required secure items are then retrieved (arrow 138, which corresponds to block/arrow 138 in FIGS. 1 and 8). International items are then signed out (arrow 1212), with the remaining items then being scanned out of the vault (block/arrow 140, which corresponds to block 140 in FIG. 1) and into the live sort (arrow 122, which corresponds to block/arrow 122 in FIGS. 1 and 8). Secure items may also be retrieved from the vault if they need to be returned to a supplier or a customer (arrow 1214), or if they have become disposable (arrow 1216). In the earlier case, the items get retrieved (arrow 138) and scanned (arrow 140) as described above, but in the latter case the items get retrieved (arrow 146, corresponding to block 146 in FIG. 1) and then scanned out and destroyed (arrow 148, which corresponds to block 148 in FIG. 1).

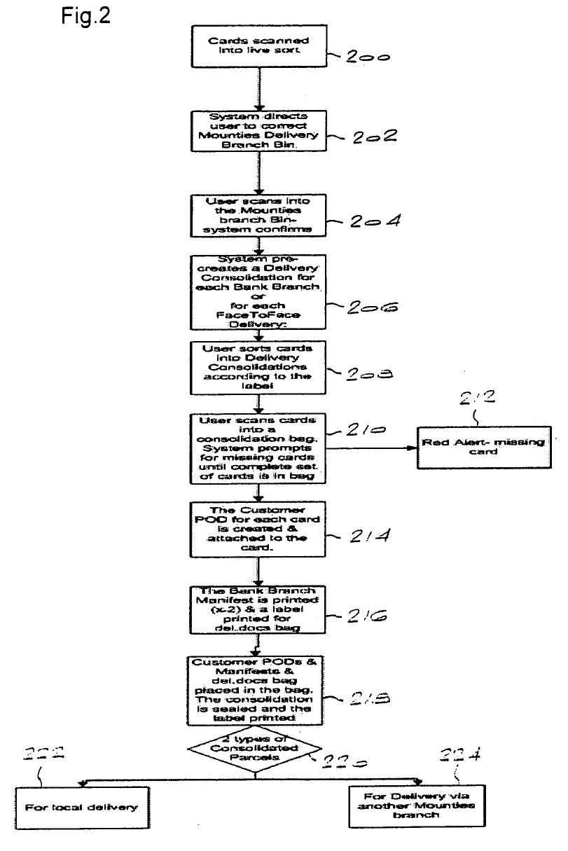

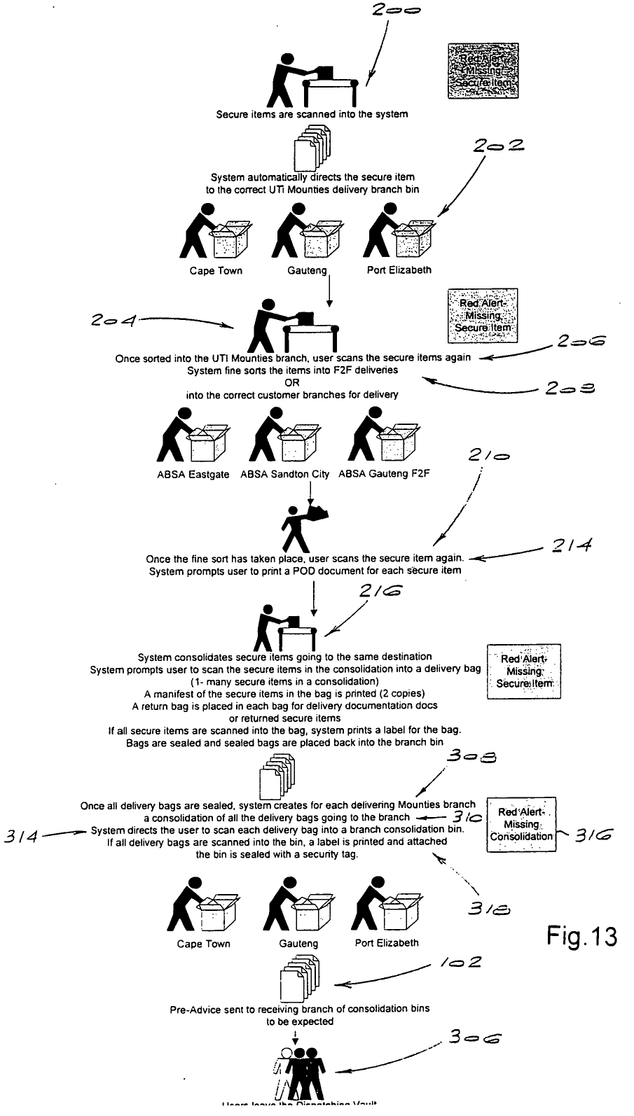

Referring to FIGS. 2 and 13, the cards which are to be delivered are scanned into a live sort section (block 200, which corresponds to block 122 in FIG. 1).

The system directs the user to place the card in the correct Mounties delivery branch bin (block/arrow 202). When the user places the card into the correct bin, they are required to scan the card which has been placed in a particular bin (block/arrow 204) and in which case the system will direct the user to place the card into the correct customer branch bin or the face-to-face delivery bin.

The system of the present invention prints a label for each card which indicates delivery to a customer bank branch or individual, and the delivery Mounties branch responsible for delivery.

The user consolidates the cards into delivery consolidations according to the label (block/arrow 208), and scans the cards into a particular consolidation bag (block/arrow 210).

The system compares the scanned cards with the pre-compiled consolidation data to ensure that each card which should be delivered to a particular bank branch or client is in fact placed in the consolidation bag.

An alarm is produced if any cards were scanned into the consolidation bag which should not have been or if any cards were not scanned into the consolidation bag which should have been (block 212).

Once all of the cards are scanned into the consolidation bag, a proof of delivery for each card is created and attached to the card (block/arrow 214).

A bank branch manifest is printed, and a label for a document delivery bag that is to deliver the secure item is also printed (block 216). The customer's proof of delivery, the bank branch manifest and the various document delivery bags are then placed within another bag (block 218).

The above process results in one of two types of consolidated parcels being produced (block 220), a first for local delivery (block 222) and a second for delivery via another Mounties branch (block 224).

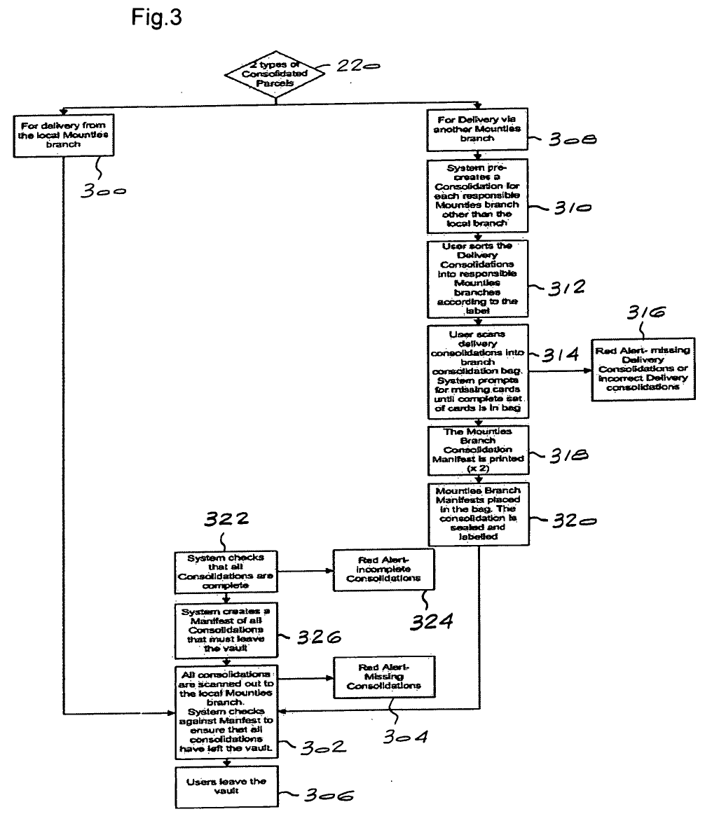

Referring to FIG. 3, if the cards are for local delivery (block 300, which corresponds to block 222 in FIG. 2), they are scanned out of the local Mounties branch and a system compares the consolidation data scanned out with the pre-compiled consolidation data to ensure that all consolidations which should be leaving the vault are in fact leaving (block 302).

An alert is produced if any consolidations are leaving which should not be leaving, or if any consolidations are not leaving which should be leaving (block 304).

The user then leaves the vault with the consolidations for delivery (block 306).

In the event of the delivery being via another Mounties branch (block 308, which corresponds to block 224 in FIG. 2), and with reference now to the rest of FIG. 13, the system creates a consolidation for each responsible Mounties branch (block/arrow 310). The user then sorts the consolidations into the responsible Mounties branches according to labels (block 312).

The user then scans the delivery consolidations into a branch consolidation bag with the system prompting for missing cards until all of the cards which should be in the consolidation bag are in fact in the consolidation bag (block/arrow 314).

An alert is produced if any delivery consolidations are in the consolidation bag which should not be or if any delivery consolidations are not in the bag which should be (block 316).

A Mounties branch consolidation manifest is printed (block/arrow 318) and placed in the bag which is then sealed and labeled (block 320).

The sealed and labeled consolidation bag is scanned out of the local Mounties branch and the scanned data is then compared against pre-captured consolidation data to ensure that the correct cards are being transported to another branch (block 302).

In the background, the system checks that all consolidations are complete (block 322). Again, an alarm is produced if any consolidations are not being transported which should have been or if any consolidations are being transported which should not be (block 324). The system then creates a manifest of all consolidations that must leave the secure vault (block 326).

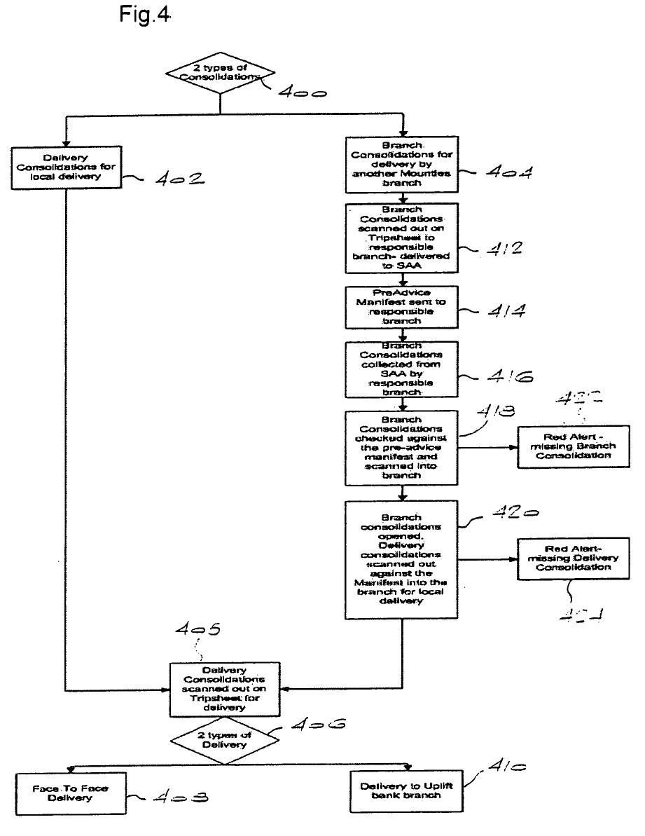

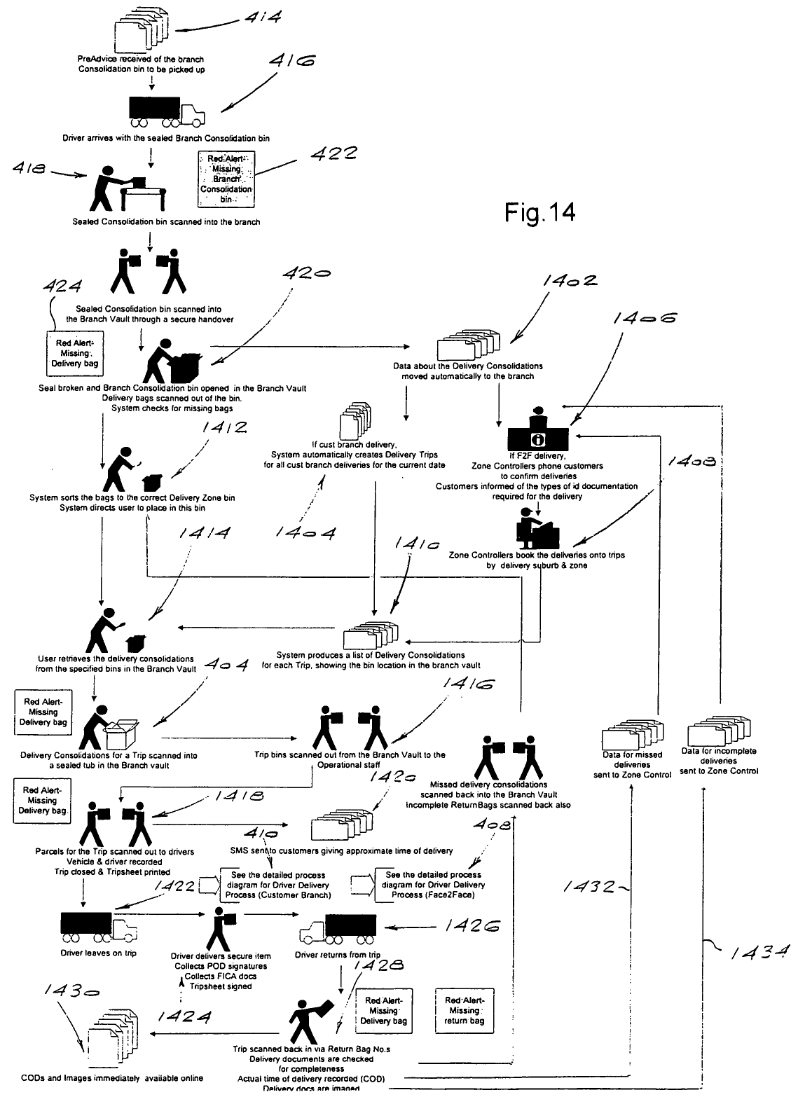

Referring to FIG. 4, the figure covers the two types of consolidations used in the present invention (block 400), namely consolidations for local delivery (block 402) and consolidations for delivery by another Mounties branch (block 404), with the second type of consolidation being shown in more detail in FIG. 14.

In the event of local delivery, each consolidation is immediately scanned out on a trip sheet for delivery (block 405). There are two types of deliveries (block 406), namely a face-to-face delivery (block 408) and a bank branch delivery (block 410).

In the event of a delivery by another Mounties branch, the consolidations are scanned on a trip sheet to the responsible branch (block 412) and pre-advice data is transmitted to the responsible branch (block 414).

The responsible branch collects the consolidation (block 416), typically from an airport, and once at the distribution centre, compares the received cards with the pre-advice data. In particular, the pre-advice data is checked both that a whole consolidation is received (block 418) and that each consolidation includes the cards which it should include (block 420).

An alarm is produced if a consolidation is not received or if any cards were received which have not have been received or if any cards were not received which should have been received (blocks 422 and 424).

Referring particularly to the rest of FIG. 14, once the delivery bags have been opened in the branch vault (arrow 420), the branch extracts the data for the delivery consolidations (arrow 1402). From this data, the branch will know whether it is a customer branch delivery (arrow 1404) or a face to face delivery (arrow 1406). For the latter, the call centre contacts the customer to confirm the delivery and then books the deliveries onto trips (arrow 1408). In any event, for both cases, the system produces a list of delivery consolidations for each trip (arrow 1410). This information is then used to allow the bags to be placed in the correct delivery zone bin (arrow 1412), for retrieval (arrow 1414). After the retrieved delivery consolidations are scanned into a sealed tub (arrow 404), they are then scanned out from the branch vault (arrow 1416), and then scanned out to drivers (arrow 1418). At this point, conveniently, an SMS is sent to customers providing them with the approximate time of delivery (arrow 1420). The driver then leaves with the parcel (arrow 1422), delivers the secure item and collects proof of delivery (POD) signatures (arrow 1424). Upon his or her return from the trip (arrow 1426), the trip is scanned back in, with the returned delivery documents being checked for completeness etc. (arrow 1428) so images of the documents associated with the delivery can be made available for inspection online (arrow 1430). Missed or incomplete deliveries are then reported to the call centre for action, as indicated by arrows 1432 and 1434.

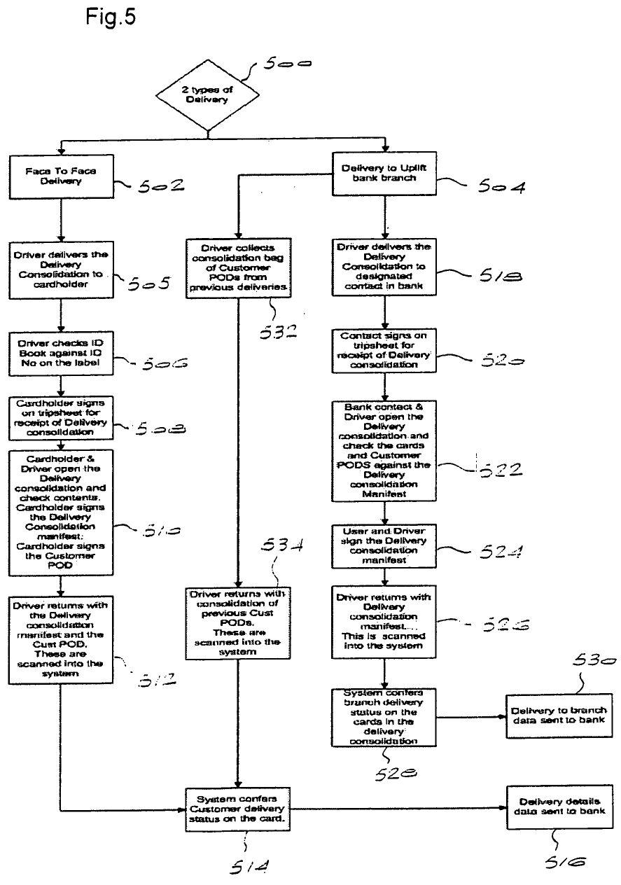

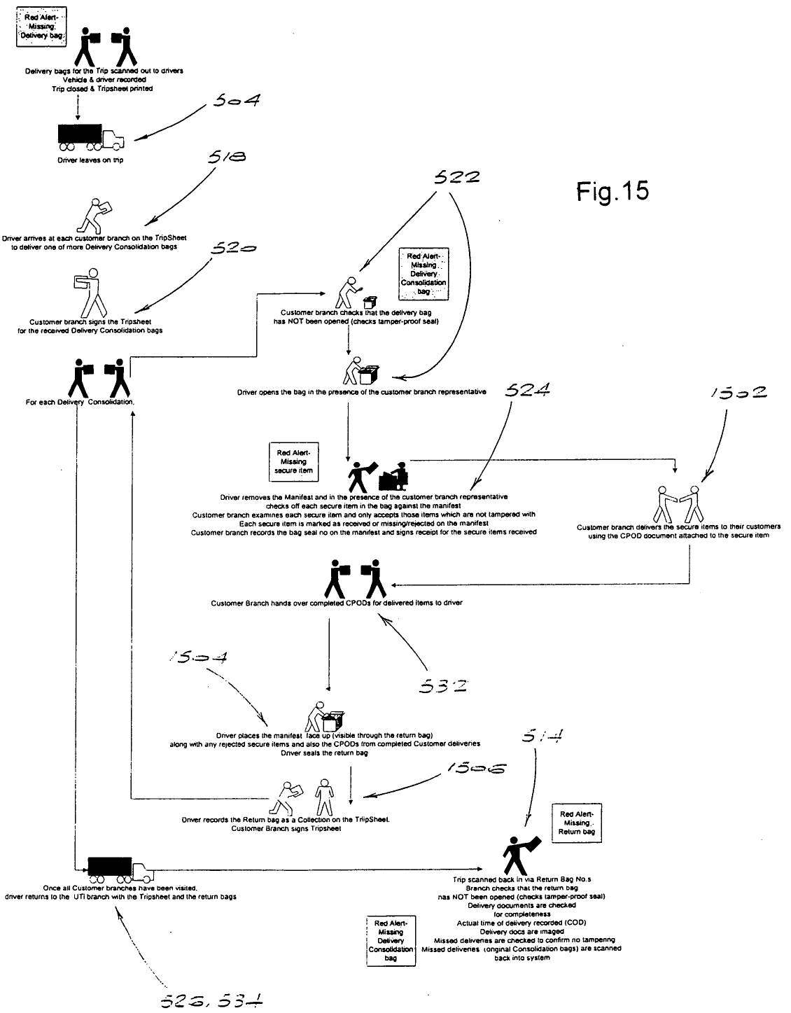

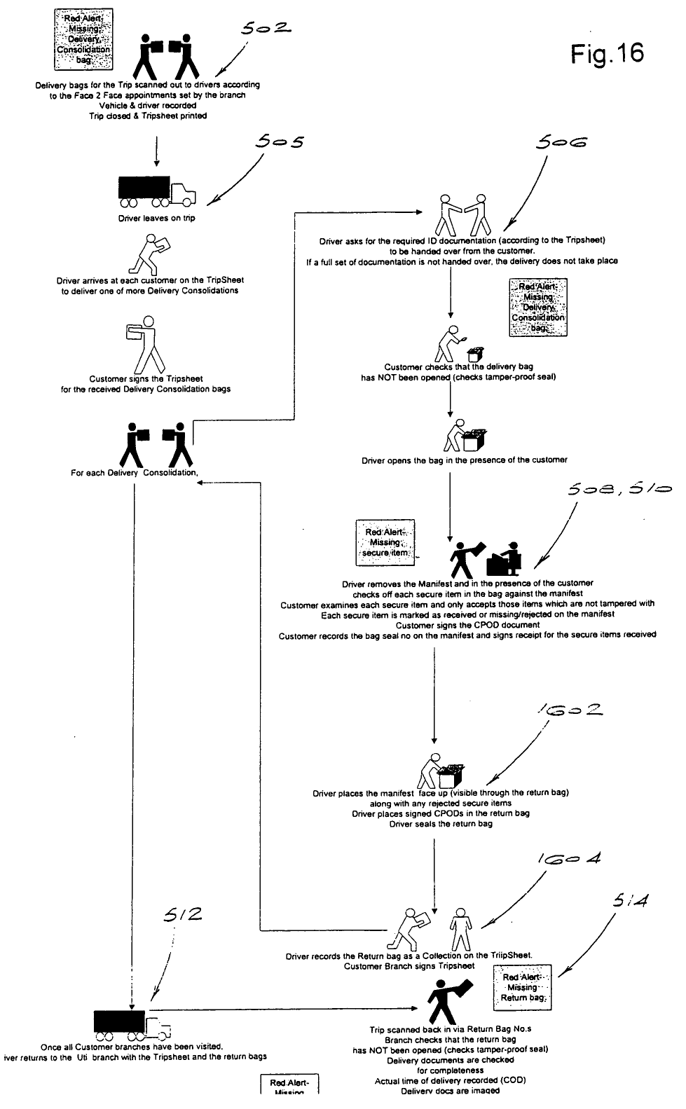

Referring to FIGS. 5, 15 and 16, as mentioned above there are two types of deliveries (block 500, which corresponds to block 406 in FIG. 4), namely either face-to-face deliveries (block 502, which corresponds to block 408 in FIG. 4, and which will be described in more detail with reference to FIG. 16) or deliveries to a bank branch (block 504, which corresponds to block 410 in FIG. 4, which will be described in more detail with reference to FIG. 15).

In the case of a face-to-face delivery (block/arrow 502), a driver delivers the consolidation to a cardholder (block/arrow 505), and for each delivery consolidation, the driver typically checks the ID Book of the cardholder against an ID number on the label (block/arrow 506).

The cardholder will sign a trip sheet to confirm receipt of the consolidation (block/arrow 508) and the cardholder and driver open the delivery consolidation and check the contents. The cardholder signs the delivery consolidation manifest and the proof of delivery (block/arrow 510). Thereafter, the driver places the signed consolidation manifest in a return bag, along with any rejected secure items (arrow 1602), and then records the return bag as a collection on the trip sheet (arrow 1604).

The driver returns with the delivery consolidation manifest and the cardholder proof of delivery which are scanned into the system and stored (block/arrow 512). The system then confers customer delivery status on the card (block/arrow 514) and the delivery status and details are transmitted to the bank (block 516).

In the event of the delivery being to a bank branch, the driver delivers the delivery consolidation to the designated contact in the bank (block/arrow 518) who signs the trip sheet for confirmation of receipt of the delivery consolidation (block/arrow 520). For each delivery consolidation, the bank contact and the driver open the delivery consolidation and check the cards and customer proof of deliveries against the delivery consolidation manifest (block/arrow 522). Both the contact in the bank and the driver signs the delivery consolidation manifest (block/arrow 524) and the driver returns with the delivery consolidation manifest which is scanned into the system (block/arrow 526). The system confers branch delivery status on the card (block 528) and this is transmitted to the bank (block 530).

In addition to delivering a consolidation, the driver will also collect consolidation bags of customer approval deliveries from previous deliveries (block/arrow 532). These occur when the customer comes into the bank to collect the card and they sign the proof of deliveries which the bank branch keeps and passes back to the delivery unit, or when the customer branch delivers the secure items to their customers (arrow 1502).

The signed manifest for delivered consolidations is then placed in a provided return bag, together with any rejected secure items as well as collected POD's provided by the customer bank (arrow 1504). The return bag then gets sealed and marked as a collection on the trip sheet (arrow 1506)

The driver returns with these proof of deliveries which are scanned into the system (block/arrow 534), and the system confers customer delivery status on the card (block/arrow 514). The delivery details are sent to the bank (block 516).

Whether the deliveries are successful or not, the system checks the deliveries and returns against the trip sheets manifest and marks that the returned consolidations has been filed in the vault.

If the combination of deliveries and returns does not compare with the trip sheet manifest an alarm is produced to indicate an error.

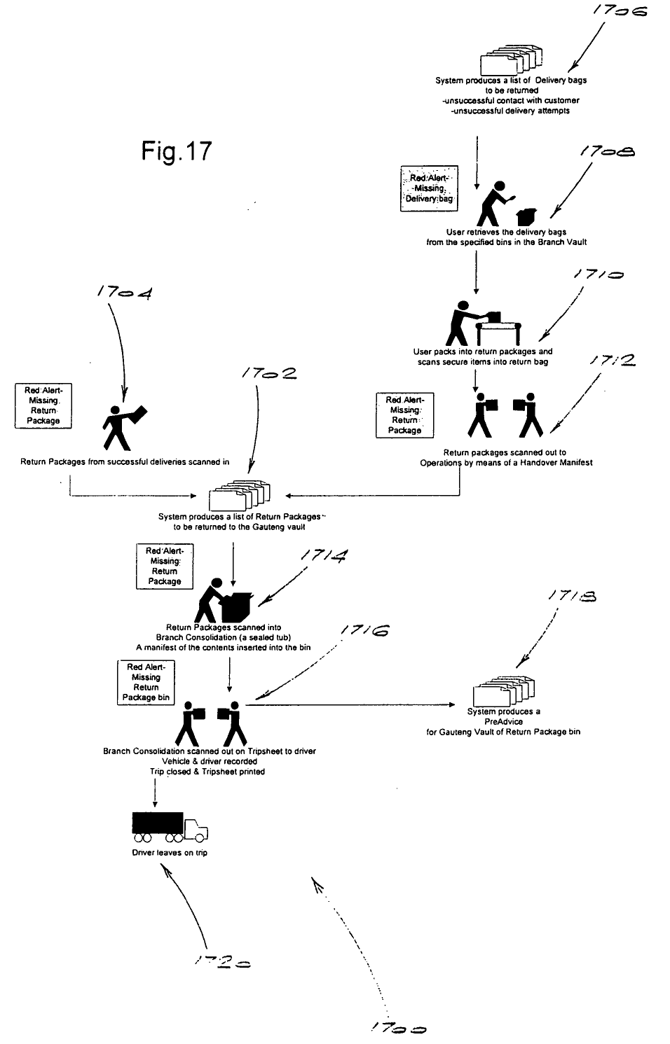

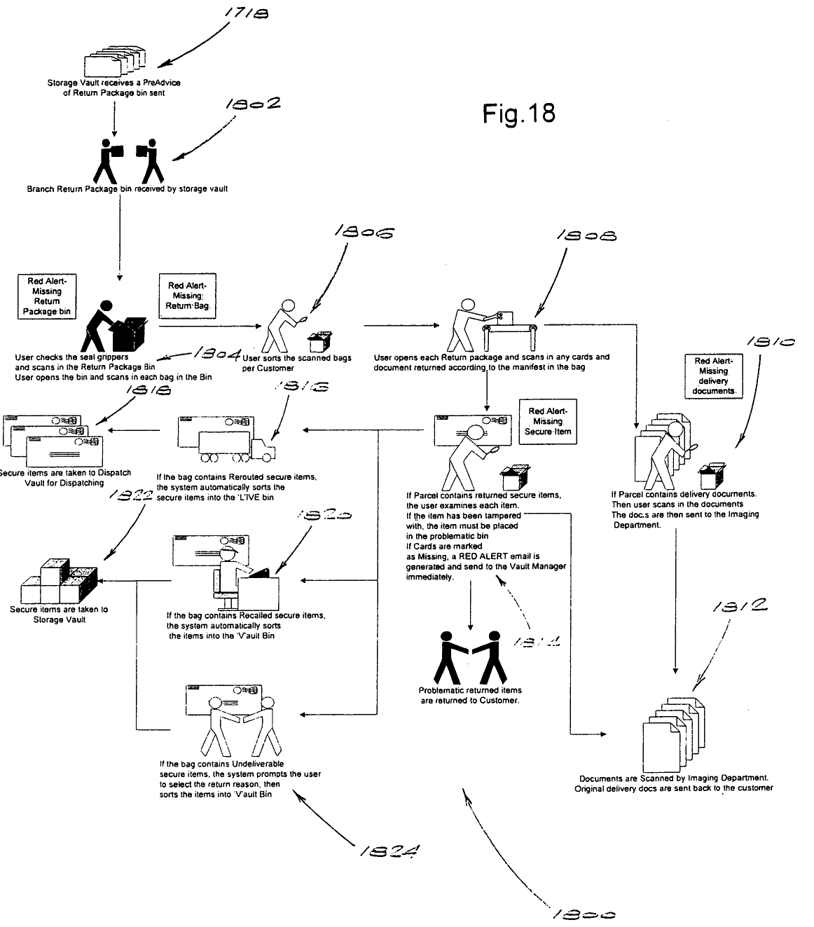

The returns process will now be described in more detail with reference to FIGS. 17 and 18, with FIG. 17 showing the process 1700 that takes place at the branch vault itself, and FIG. 18 showing the process 1800 that takes place at a central secure vault.

In FIG. 17, the system produces a list of return packages that needs to be returned to a central secure vault (arrow 1702). The source of this list comprises the return packages from successful deliveries (arrow 1704) and a list of delivery bags to be returned because of either unsuccessful contact or unsuccessful delivery (arrow 1706). In the latter, the delivery bags to be returned are retrieved (arrow 1708), packed into return packages (arrow 1710) and then scanned out (arrow 1712). All the return packages are then scanned into a sealed consolidation tub (arrow 1714), and then scanned out on a driver's trip sheet (arrow 1716). At this point, the system produces a preadvice, which then gets sent to the central vault informing it of the returns that it will shortly be receiving (arrow 1718). The driver then leaves with the return packages, headed for the central vault (arrow 1720).

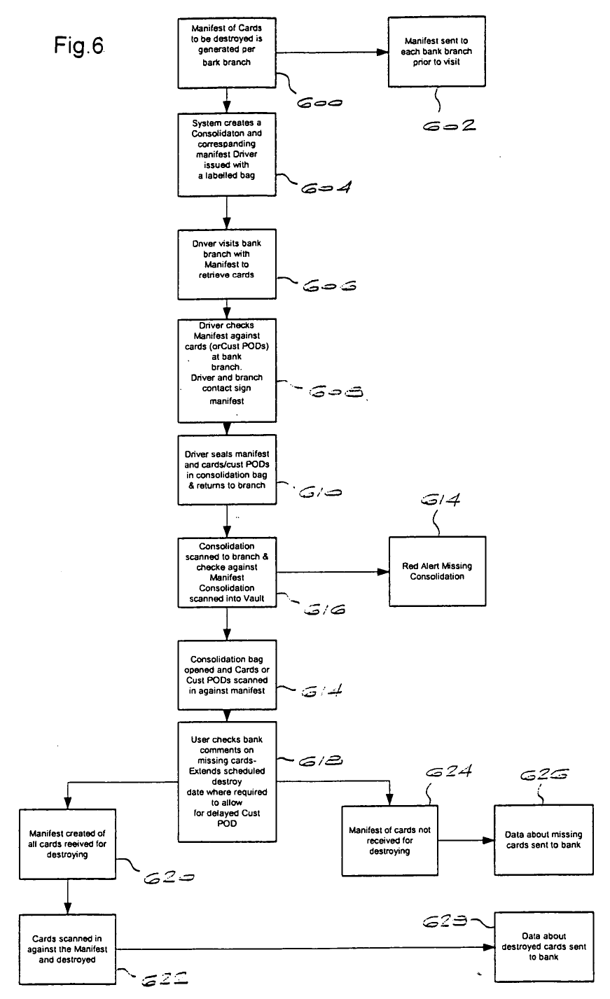

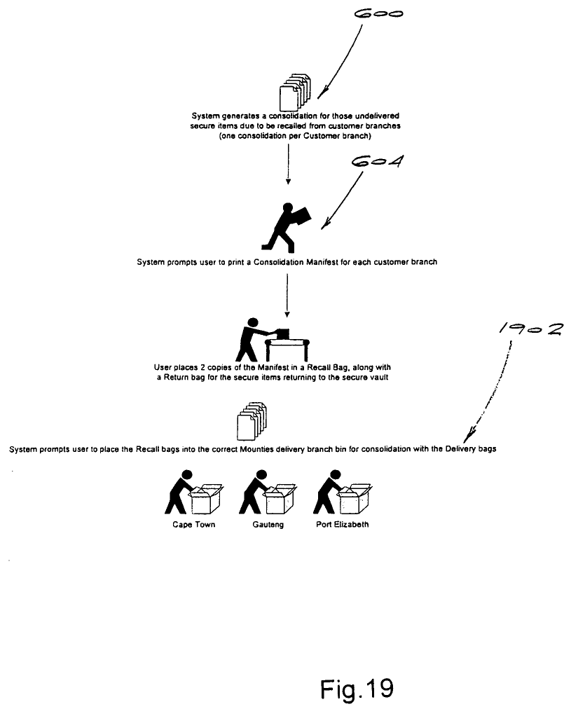

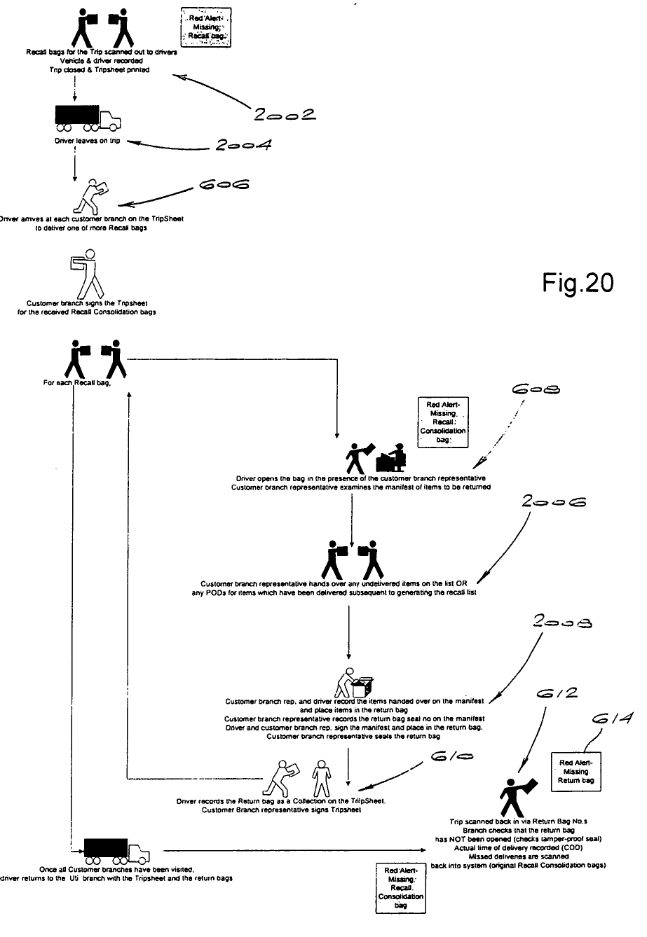

Turning now to FIG. 18, at the central vault, the preadvice is received (arrow 1718), with the branch return packages then being received shortly thereafter (arrow 1802). The return package bin is then scanned in, with the bin then being opened so that each return package within the bin can be scanned (arrow 1804). The scanned bags are then sorted per customer (arrow 1806). Each return package is then opened, with any cards or documents within the package then also being scanned in (arrow 1808). Depending on the contents, any one of the following actions will be taken:
1. If the parcel contains delivery documents, the documents are scanned in and then sent to the imaging department (arrow 1810). The imaging department then scans in the documents (arrow 1812), with the original delivery documents then being sent back to the customer.
2. If the parcel contains returned secure items, these items are examined. If the item has been tampered with, the item is placed in a problematic bin and then sent to the imaging department for scanning (arrow 1814). If a card is marked as missing, a Red Alert e-mail is generated and sent to a vault manager.
3. If the bag contains rerouted secure items, the system automatically sorts the secure items into the live bin (arrow 1816). The secure items are then taken to the dispatch vault for dispatching (1818).
4. If the bag contains recalled secure items, the system automatically sorts the items into the vault bin (arrow 1820), after which the secure items are taken to the storage vault (arrow 1822). Recalled items will be described in more detail further below with reference to FIGS. 6, 19 and 20.
5. If the bag contains undeliverable secure items, these are sorted back into the vault (arrow 1824).

Referring to FIGS. 6, 19 and 20, these figures illustrate what occurs when cards are recalled and destroyed. This typically occurs either because they are nearing the eight-week cycle without customer proof of delivery or on request from the bank branch (block/arrow 600).

In any event, a manifest of cards to be destroyed is generated per bank branch and transmitted to the bank branch prior to the visit by the delivery agent (block 602).

The system creates a consolidation and corresponding manifest and the driver is issued with a labeled bag (block/arrow 604). The system then prompts the user to place the recall bags into the correct delivery branch bin for consolidation with the delivery bags that are going to the various delivery branches (arrow 1902).

The recall bags for the trip are then scanned out to drivers (arrow 2002), with the driver then leaving on his/her trip (arrow 2004). The driver visits the bank branch with the manifest to retrieve the cards (block/arrow 606). For each recall bag, the driver and branch contact check the manifest against the cards and sign the manifest (block/arrow 608, and arrows 2006 and 2008). The driver seals the manifest and cards in the consolidation and returns to the distribution centre (block/arrow 610).

At the distribution centre, consolidation data is captured and checked against the manifest consolidation (block/arrow 612). An alarm is produced if any consolidations are missing (block/arrow 614).

The bag is then opened and the cards are scanned in (block 616). The user checks the bank comments on missing cards and extends the scheduled destroy date where required to allow for delayed customer proof of delivery (block 618).

A manifest is created of all cards received for destroying (block 620) and the cards are then scanned in against the manifest and destroyed (block 622).

Alternatively, a manifest of cards not received for destroying is scanned in (block 624). In either case, data is transmitted to the bank about the missing cards (blocks 626 and 628).

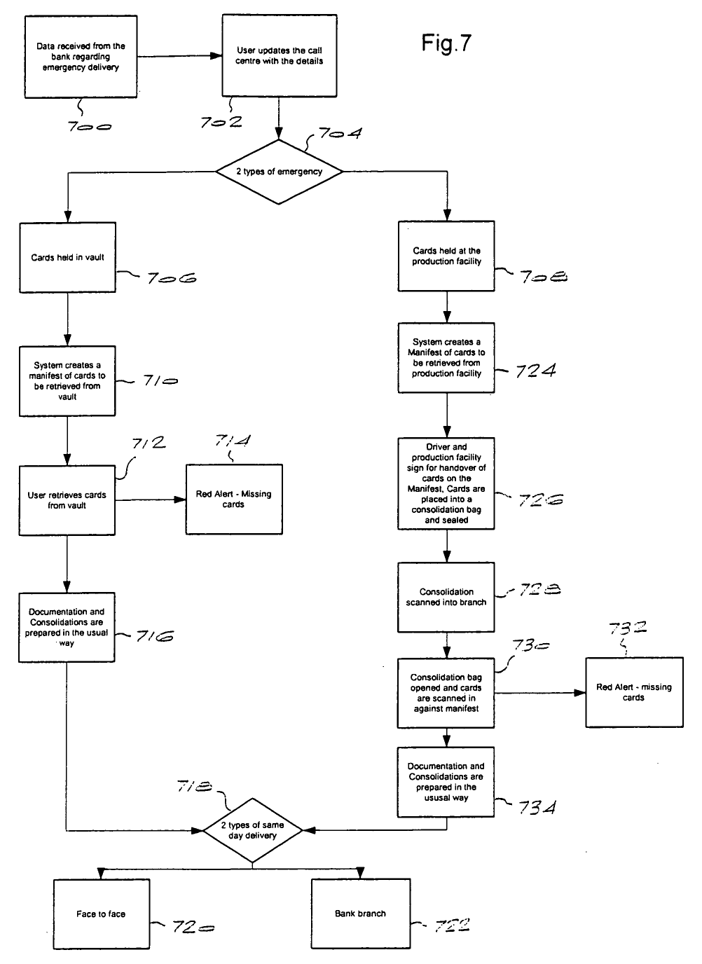

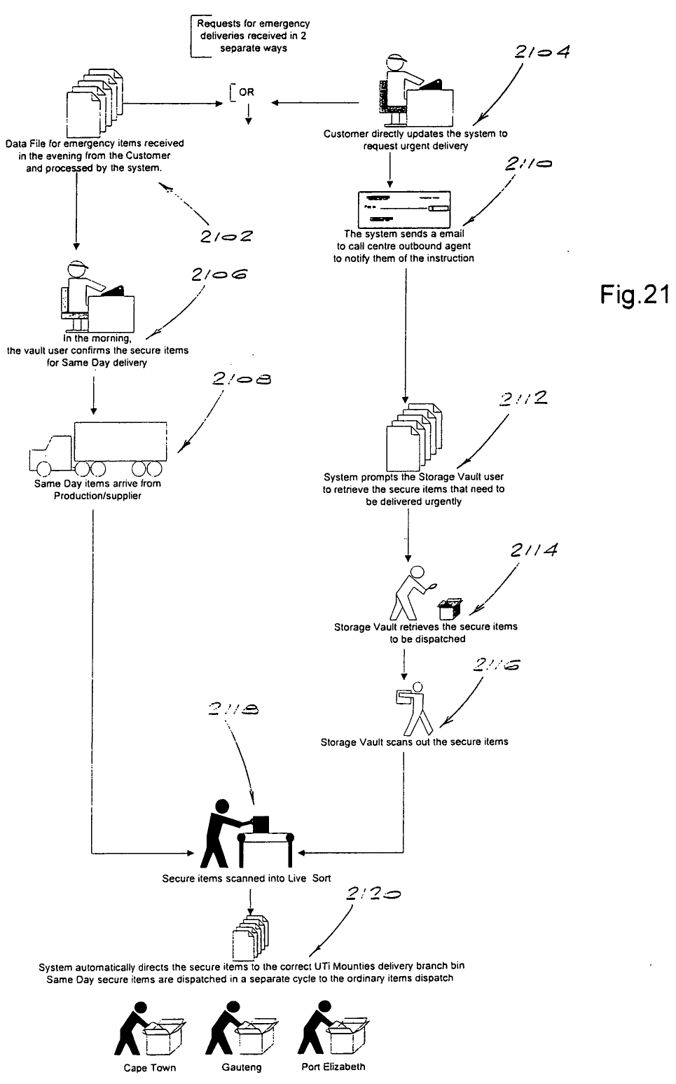

FIGS. 7 and 21 illustrate two process for an emergency card delivery. First with reference to FIG. 7, pre-delivery data is received at the distribution server from the bank regarding the emergency delivery, the details and the card to be delivered (block 700). This information is used to update the call centre (block 702).

There are two types of emergency deliveries (block 704), one where the card is already held in the vault at the distribution centre (block 706) and the second where the card is held at the production facility (block 708).

If the card is held in the vault at the distribution centre, the system creates a manifest of cards to be retrieved from the vault (block 710), and a user retrieves the cards from the vault (block 712). An alert is produced if the card is missing (block 714). The documentation and consolidations are prepared in much the same way as has been described above (block 716), and the delivery is effected in one of two ways (block 718), either face-to-face (block 720) or to the bank branch (block 722), again as has been described above.

In the event that the cards are held at the production facility, the system creates a manifest of cards to be retrieved from the production facility (block 724). The driver and production facility sign for handover of cards on the manifest. The cards are placed into a consolidation bag and sealed (block 726). The consolidation bag is returned to the distribution centre and scanned in (block 728).

The consolidation bag is opened and cards are scanned against the manifest (block 730). Again, an alarm is produced if a card is missing (block 732).

The necessary documentation and consolidation are prepared as has been described above (block 734), and delivery again occurs as has been described above.

Turning now to FIG. 21, a request for an emergency delivery may be received in one of two different ways. Either a customer bank may send a data file for emergency items to the distribution server (arrow 2102) or the customer bank may directly update the system to request an urgent delivery (arrow 2104). In the former, the distribution server confirms the items for same day delivery (arrow 2106) with the requested items then arriving from the supplier (arrow 2108). In the latter, the call centre gets notified of the urgent request (arrow 2110), the system prompts the storage vault user to retrieve the urgently required item from the vault (arrow 2112), the item is retrieved from the vault (arrow 2114) and then scanned out of the vault (arrow 2116). In both cases, the secure items are then scanned into the live sort (arrow 2118) and then directed towards the correct delivery branch bin (arrow 2120). The items are then dispatched in the manner described above.

I claim:

1. A method of distributing secure items, monitoring the distribution process and producing alarms in the event of errors, the method comprising the steps of:
receiving pre-delivery data at a distribution server, the data detailing a plurality of secure items which will be received at a distribution centre;
receiving a plurality of secure items at the distribution centre and capturing data identifying the received plurality of secure items;
comparing the data identifying the received plurality of secure items with the received pre-delivery data; and
producing an alarm if any secure items was received which should not have been received or if any secure item was not received which should have been received.

2. A method according to claim 1, which further includes the step of determining whether each received secure item is ready for delivery to a customer.

3. A method according to claim 2, wherein if the received secure item is ready for delivery, the method further includes the steps of:
compiling delivery data detailing the secure item to be delivered;
preparing the secure item to be delivered and capturing data detailing the prepared secure item to be delivered;
comparing the delivery data with the data captured from the prepared secure item to be delivered; and
producing an alarm if any secure item was prepared for delivery which should not have been or if any secure item was not prepared for delivery which should have been.

4. A method according to claim 3, which further includes the steps of:
compiling data detailing whether the prepared secure item was successfully delivered or whether it was returned to the distribution centre;
comparing the compiled data with the delivery data; and
producing an alarm if the secure item was neither delivered nor returned.

5. A method according to claim 2, wherein if the received secure item is not ready for delivery, the method further includes the step of scanning the secure item into a vault.

6. A method according to claim 5, which further includes the steps of:
receiving retrieval order data for a secure item;
scanning the ordered secure item out of the vault;
preparing the ordered secure item to be delivered and capturing data detailing the ordered secure item to be delivered;
comparing the retrieval order data with the data captured from the prepared ordered secure item to be delivered; and
producing an alarm if any secure item was prepared for delivery which should not have been or if any secure item was not prepared for delivery which should have been.

7. A method according to claim 5, which further includes the steps of:
monitoring the duration that a secure item is stored in the vault; and
when the duration of the secure item in the vault exceeds a predetermined amount, the method further includes the steps of:
compiling destruction data detailing the secure item to be destroyed;
preparing the secure item to be destroyed and capturing data detailing the secure item to be destroyed;
comparing the destruction data with the data captured from the prepared secure item to be destroyed; and
producing an alarm if any secure item was prepared for destruction which should not have been or if any secure item was not prepared for destruction which should have been.

8. A method according to claim 1, which further includes the steps of:
compiling pre-delivery data at the distribution server, the data detailing a plurality of secure items which are to be delivered to a remote distribution centre; and
sending the pre-delivery data to the remote distribution centre.

9. A method according to claim 8, which further includes the steps of:
preparing the plurality of secure items to be delivered to the remote distribution centre and capturing data detailing the plurality of secure items to be delivered;
comparing the pre-delivery data with the data captured from the prepared plurality of secure items to be delivered to the remote distribution centre; and
producing an alarm if any secure item was prepared for delivery to the remote distribution centre which should not have been or if any secure item was not prepared for delivery to the remote distribution centre which should have been.

10. A system for distributing secure items, monitoring the distribution process and producing alarms in the event of errors, the system comprising a processor that can:
receive pre-delivery data, the data detailing a plurality of secure items which will be received at a distribution centre;
capture data identifying a plurality of secure items received at the distribution centre;
compare the data identifying the received plurality of secure items with the pre-delivery data; and
produce an alarm if any secure item was received which should not have been received or if any secure item was not received which should have been received.

11. A system according to claim 10, wherein the processor can determine whether the received secure item is ready for delivery.

12. A system according to claim 11, wherein if the received secure item is ready for delivery, the processor can:
compile delivery data detailing the secure item to be delivered;
capture data detailing a secure item that has been prepared for delivery;
compare the compiled delivery data with the data captured from the prepared secure item to be delivered; and
produce an alarm if any secure item was prepared for delivery which should not have been or if any secure item was not prepared for delivery which should have been.

13. A system according to claim 11, wherein if the received secure item is not ready for delivery, the system further includes a scanner for scanning the secure item into a vault.

14. A system according to claim 13, wherein the processor can:
receive retrieval order data for a secure item;
scan the ordered secure item out of the vault;
capture data detailing an ordered secure item that has been prepared for delivery;
compare the retrieval order data with the data captured from the prepared ordered secure item to be delivered; and
produce an alarm if any secure item was prepared for delivery which should not have been or if any secure item was not prepared for delivery which should have been.

15. A system according to claim 13, wherein the processor can:
monitor the duration that a secure item is stored in the vault; and
when the duration of the secure item in the vault exceeds a predetermined amount, the processor can:
compile destruction data detailing the secure item to be destroyed;
capture data detailing the secure item that has been prepared for destruction;
compare the destruction data with the data captured from the prepared secure item to be destroyed; and
produce an alarm if any secure item was prepared for destruction which should not have been or if any secure item was not prepared for destruction which should have been.

16. A system according to claim 10, wherein the processor can:
compile pre-delivery data at a distribution server, the data detailing a plurality of secure items which are to be delivered to a remote distribution centre; and
send the pre-delivery data to the remote distribution centre.

17. A system according to claim 16, wherein the processor can:
capture data detailing a prepared plurality of secure items to be delivered to the remote distribution centre;
compare the pre-delivery data with the data captured from the prepared plurality of secure items to be delivered to the remote distribution centre; and
produce an alarm if any secure item was prepared for delivery to the remote distribution centre which should not have been or if any secure item was not prepared for delivery to the remote distribution centre which should have been.
